(19) United States
(12) Patent Application Publication
(10) Pub. No.: US 2018/0011953 A1
(43) Pub. Date: Jan. 11, 2018

(54) Virtual Sensor Data Generation for Bollard Receiver Detection

(71) Applicant: Ford Global Technologies, LLC, Dearborn, MI (US)

(72) Inventors: Ashley Elizabeth Micks, Mountain View, CA (US); Scott Vincent Myers, Camarillo, CA (US); Harpreetsingh Banvait, Sunnyvale, CA (US); Sneha Kadetotad, Cupertino, CA (US)

(21) Appl. No.: 15/204,484

(22) Filed: Jul. 7, 2016

(51) Int. Cl. G06F 17/50; G06N 99/00

(52) U.S. Cl. CPC G06F 17/5009; G06N 99/005

(57) ABSTRACT

The disclosure relates to methods, systems, and apparatuses for virtual sensor data generation and more particularly relates to generation of virtual sensor data for training and testing models or algorithms to detect objects or obstacles, such as bollard receivers. A method for generating virtual sensor data includes simulating a 3-dimensional (3D) environment that includes one or more objects, such as bollard receivers. The method includes generating virtual sensor data for a plurality of positions of one or more sensors within the 3D environment. The method includes determining virtual ground truth corresponding to each of the plurality of positions. The ground truth includes information about at least one bollard receiver within the sensor data. For example, the ground truth may include a height of the at least one of the parking barriers. The method also includes storing and associating the virtual sensor data and the virtual ground truth.

### TECHNICAL FIELD

The disclosure relates generally to methods, systems, and apparatuses for virtual sensor data generation and more particularly relates to generation of virtual sensor data for training and testing models or algorithms to detect or avoid objects or obstacles, such as bollard receivers.

### BACKGROUND

Automobiles provide a significant portion of transportation for commercial, government, and private entities. Due to the high value of automobiles and potential harm to passengers and drivers, driver safety and avoidance of accidents or collisions with other vehicles, barriers, or objects are extremely important.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a vehicle control system that includes an automated driving/assistance system, according to one implementation;

FIG. 2 illustrates a plurality of bollards located in bollard receivers, according to one implementation;

FIG. 3 illustrates a plurality of bollard receivers with the bollards removed, according to one implementation;

FIG. 4 is a schematic block diagram illustrating an implementation of a system for sensor data generation;

FIG. 5 is a schematic diagram illustrating a side view of a vehicle located near a bollard receiver;

FIG. 6 is an example complimentary frame of the frame illustrated in FIG. 3, according to one implementation;

FIG. 7 is a schematic block diagram illustrating example components of a simulation component, according to one implementation; and

FIG. 8 is a schematic flow chart diagram illustrating a method for generating virtual sensor data, according to one implementation.

### DETAILED DESCRIPTION

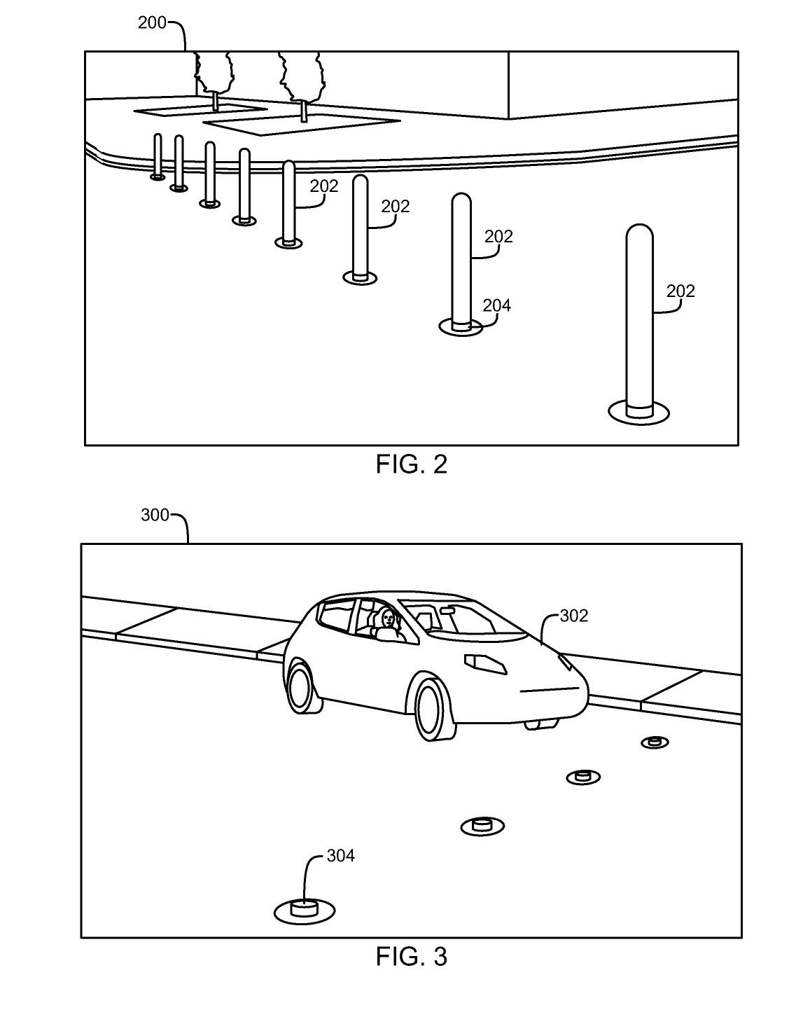

Bollards are often used to direct traffic, reroute or block traffic on a roadway, or selectively block or allow access to a parking lot, driveway, or other driving location (e.g., see FIG. 2). In some cases, bollards are removable and have a corresponding bollard receiver grounded inside the road or driving path (e.g., see FIG. 3). The sizes and heights of bollard receivers vary, and sometimes drivers do not detect them. These bollard receivers can cause severe damage to the vehicle if they are not noticed and vehicle is driven over them. Driving over them can cause the vehicle tires to get damaged. Depending on how high the receivers extend above the ground, vehicle parts, such as the front suspension, can be damaged.

In order to avoid such a collision and the resulting damage, Applicants have recognized that it may be beneficial to know both the position and the height of the bollard receiver. A driver, or control system of an automated vehicle, may be notified of the presence and/or height of the bollard receiver so that a path can be generated that avoids impact with the bollard receivers, if needed. Applicants have also recognized that training of detection algorithms on large amounts of diverse data may also be needed. However, real world sensor data takes considerable time and resources to acquire, by setting up physical tests or driving around with sensors to collect data for relevant scenarios.

In recognition of the foregoing, Applicants have developed systems, methods, and devices for generation of virtual sensor data and ground truth. In one embodiment, a system uses a 3-dimensional (3D) virtual environment to generate virtual sensor data that is automatically annotated with ground truth for the presence and/or dimensions of a bollard receiver. For example, the ground truth may include locations and heights of bollard receivers. The virtual sensor data and/or the annotations may then be used for training and/or testing of detection algorithms or models. Compared to real-world data with human annotations, embodiments of virtual data generated using embodiments of systems, methods, and devices disclosed herein is cheaper in terms of time, money, and resources. For example, in a few minutes thousands of virtual images and associated ground truth may be generated in contrast with hours or months in acquiring a similar number of real-world images. Embodiments disclosed herein combine virtual sensor data with automatic annotations useful to training and testing bollard receiver detection and navigation algorithms.

According to one embodiment, a system may integrate a virtual driving environment, created using 3D modeling and animation tools, with sensor models to produce virtual sensor data in large quantities in a short amount of time. Relevant parameters, such as lighting, positioning, size, and appearance of the bollard receiver, may be randomized in the recorded data to ensure a diverse dataset with minimal bias. In one embodiment, virtual sensors are positioned relative to the roadway (or other driving environment) according to their planned positioning on a vehicle. During simulation, the virtual sensors may be moved along a virtual road or driving path into locations where they can observe bollard receivers.

As the virtual sensors are moved during the simulation, the virtual sensors record data, such as simulated images, simulated radar data, simulated LIDAR data, simulated ultrasound data, or other simulated data. For each time-step of recorded data (for example, each frame of camera data), annotations are automatically provided to record ground truth information about the positions of all bollard receivers within range (and/or an observation region) of the sensor. Additionally, dimensions such as the height of each bollard receiver may also be determined as included in the annotations. In the case of virtual camera data, for example, each frame of image data may have a complimentary entry in a log file that lists the pixel location and size of the bounding boxes around any bollard receivers, the xyz position of the receiver relative to the ego vehicle (e.g., a parent vehicle or a vehicle with a vehicle control system), and/or the height of the receiver from the ground. This virtual ground truth information can be used to train a perception algorithm using supervised learning, or to test and existing algorithm and quantify its performance.

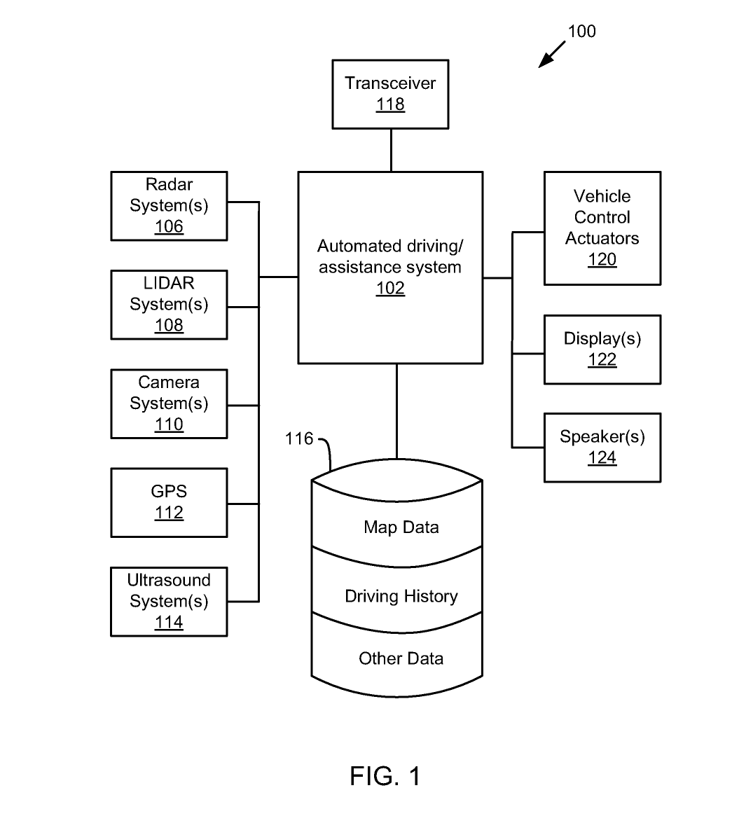

Referring now to the figures, FIG. 1 illustrates an example vehicle control system 100 that may be used to automatically detect bollard receivers. The vehicle control system 100 may comprise an automated driving/assistance system 102 that may be used to automate or control operation of a vehicle or to provide assistance to a human driver. For example, the automated driving/assistance system 102 may control one or more of braking, steering, acceleration, lights, alerts, driver notifications, radio, or any other auxiliary systems of the vehicle. In another example, the automated driving/assistance system 102 may not be able to provide any control of the driving (e.g., steering, acceleration, or braking), but may provide notifications and alerts to assist a human driver in driving safely. The automated driving/assistance system 102 may use a neural network, or other model or algorithm to determine that a bollard receivers is present and may also determine a size, location, and/or dimensions of an object or obstacle, such as a bollard receiver.

The vehicle control system 100 also includes one or more sensor systems/devices for detecting a presence of nearby objects or determining a location of a parent vehicle (e.g., a vehicle that includes the vehicle control system 100). For example, the vehicle control system 100 may include one or more radar systems 106, one or more LIDAR systems 108, one or more camera systems 110, a global positioning system (GPS) 112, and/or one or more ultra sound systems 114. The vehicle control system 100 may include a data store 116 for storing relevant or useful data for navigation and safety, such as map data, driving history, or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle, such as electric motors, switches or other actuators, to control braking, acceleration, steering or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator, which may be seen by a driver or passenger of a vehicle. The speakers 124 may include one or more speakers of a sound system of a vehicle or may include a speaker dedicated to driver notification.

It will be appreciated that the embodiment of FIG. 1 is given by way of example only. Other embodiments may include fewer or additional components without departing from the scope of the disclosure. Additionally, illustrated components may be combined or included within other components without limitation.

In one embodiment, the automated driving/assistance system 102 is configured to control driving or navigation of a parent vehicle. For example, the automated driving/assistance system 102 may control the vehicle control actuators 120 to drive a path on a road, parking lot, driveway, or other location. For example, the automated driving/assistance system 102 may determine a path based on information or perception data provided by any of the components 106-118. The sensor systems/devices 106-110 and 114 may be used to obtain real-time sensor data so that the automated driving/assistance system 102 can assist a driver or drive a vehicle in real-time. The automated driving/assistance system 102 may implement an algorithm or use a model, such as a deep neural network, to process the sensor data and identify a presence, location, height, and/or dimension of a bollard receiver, object, or other obstacle. However, in order to train or test a model or algorithm, large amounts of sensor data may be needed.

Referring now to FIG. 2, a picture or image 200 of a plurality of bollards 202 is illustrated. The bollards 202 are shown distributed across a roadway. The bollards 202 may be used to restrict traffic along the roadway, for example, to allow pedestrians to safely cross a street or intersection. In one embodiment, each of the bollards 202 may be selectively removed or installed in a corresponding bollard receiver 204 to provide the ability to selectively allow or block traffic. For example, the bollards 202 may be installed in the bollard receivers 204 during events when there may be large number of pedestrians and it is desired to block traffic along the roadway or through the intersection. Similarly, the bollards 202 may be removed from the bollard receivers 204 when it is desirable for traffic to move through the roadway or intersection. However, even when the bollards 202 are removed from the receivers 204, the receivers 204 must generally remain in or on the roadway.

FIG. 3 illustrates a frame 300 representing a picture or image of a roadway with bollard receivers 304 where the bollards (such as bollards 202) have been removed. Due to the absence of the bollards, a vehicle 302 may be allowed to drive along the roadway. However, bollard receivers 304 sometimes extend some height above a roadway and may present a risk of damaging portions of a vehicle, reducing driver or passenger comfort, or otherwise interrupting driving of a 302. In one embodiment, an automated driving/assistance system 102 (e.g., in the 302) may detect and localize the bollard receivers 304 and determine a driving maneuver or driving path to avoid causing damage to the 302. The automated driving/assistance system 102 may determine a path that includes avoiding impact with the bollard receivers 304. In one embodiment, the automated driving/assistance system 102 may determine a path that cause one or more tires to impact the bollard receivers 304 with a tread of the one or more tires. For example, bollard receivers 304 may have metal edges that can be particularly damaging to sidewalls of vehicle tires. In one embodiment, the automated driving/assistance system 102 may determine that the bollard receivers 304 extend to a height sufficient to cause damage an undercarriage or other part of the 302 and may cause the 302 to stop before impacting a bollard receiver 304 or maneuver around a bollard receiver 304 without passing over any other bollard receivers 304.

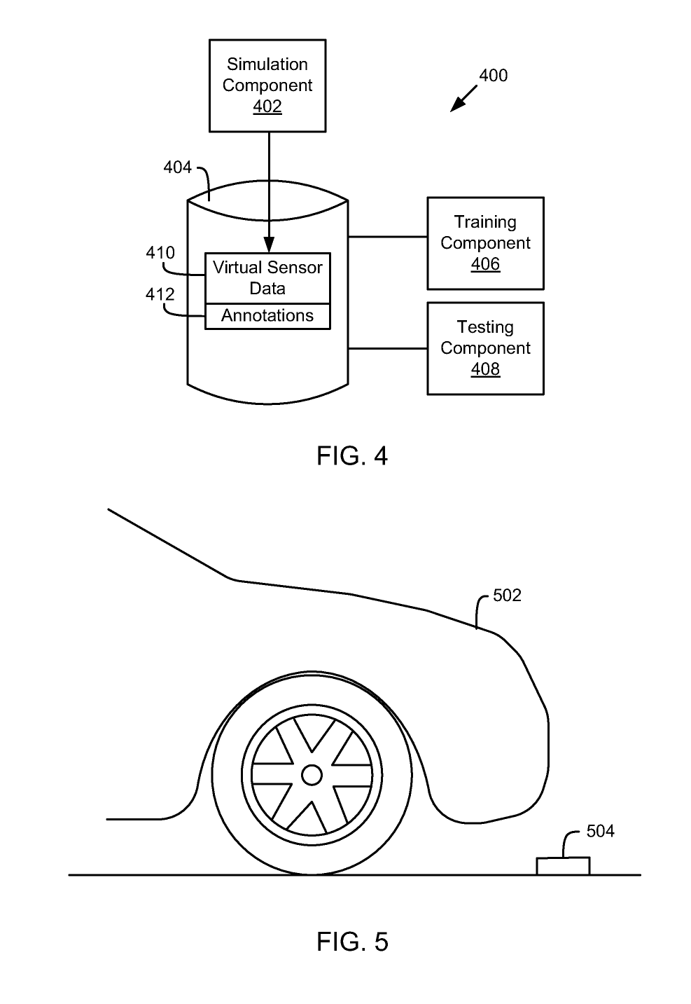

Referring now to FIG. 4, one embodiment of a system 400 for sensor data generation is shown. The system 400 includes a simulation component 402, storage 404, a training component 406, and a testing component 408. The simulation component 402 may be configured to simulate a driving environment and generate virtual sensor data 410 and virtual ground truth or other information as annotations 412 for the virtual sensor data 410. The annotations may include any type of ground truth, such as simulation conditions used by the simulation component 402 to generate the driving environment and/or virtual sensor data 410. For example, the virtual ground truth may include a virtual distance between a sensor and a virtual bollard receiver, one or more dimensions of the virtual bollard receiver (e.g., the height), or any other object or obstacle. Similarly, the virtual ground truth may include one or more details about lighting conditions, weather conditions, sensor position, sensor orientation, sensor velocity, and/or virtual sensor type (e.g., a specific model of sensor). The simulation component 402 may annotate frames or sets of virtual sensor data with the corresponding ground truth or store the virtual ground truth with an indication of the sensor data to which the virtual ground truth belongs.

The virtual sensor data 410 and/or any information for inclusion in annotations 412 may be stored in storage 404. Storage 404 may include long term storage such as a hard disk or machine storage such as random access memory (RAM). The virtual sensor data 410 and any associated annotations 412 may be stored as part of the same file or may be stored in separate files. The training component 406 and/or the testing component 408 may then access and use the virtual sensor data 410 and/or annotations 412 for training or testing a bollard receiver detection algorithm or model. The training component 406 and/or the testing component 408 may alternatively/additionally be used to access and use the virtual sensor data 410 and/or annotations 412 for training or testing a path algorithm or model that determines how and when to avoid bollard receivers during driving.

The training component 406 is configured to train a machine learning algorithm using virtual sensor data 410 and ground truth and any associated annotations 412 generated by the simulation component 402. For example, the training component 406 may train a machine learning algorithm or model by providing at least a portion of the virtual sensor data 410 and corresponding virtual ground truth and associated annotations 412 to train the machine learning algorithm or model to determine one or more of a height and a position of the one or more bollard receivers, objects, or other obstacles. The training component 406 may provide the virtual sensor data 410 and virtual ground truth and associated annotations 412 to a training algorithm for a neural network. For example, the training component 406 may train a neural network using one frame of sensor data and associated ground truth at a time. In one embodiment, the training component 406 may train a plurality of different machine learning models to identify different aspects of virtual sensor data. For example, one model may be used to classify an object in a virtual sensor frame as a bollard receiver, while another one or more other models may be used to determine a position, orientation, distance, and/or dimension of the bollard receiver, object, or other obstacle.

The testing component 408 may test a machine learning algorithm or model using the virtual sensor data 410 and virtual ground truth and any associated annotations 412. For example, the testing component 408 may provide at least a portion of the virtual sensor data 410 to the machine learning algorithm or model to determine one or more of a height and a position of the bollard receiver, object, or other obstacle and compare a determined height or a determined position with the virtual ground truth. The testing component 408 may be able to accurately determine how well a model or algorithm performs because a determined classification or value may be compared with the virtual ground truth. If an algorithm or model is sufficiently accurate, it may be implemented as part of an automated driving/assistance system 102.

FIG. 5 illustrates a side view of a vehicle 502 and a bollard receiver 504. If the bollard receiver 504 is too tall and the vehicle 502 does not stop short of the bollard receiver 504, the bollard receiver 504 may impact, scrape, or damage a wheel, suspension, or other portion of the vehicle 502. Based on the height of the bollard receiver 504, a driving path may be determined that is safe and will likely not cause damage to the vehicle. For example, the driving path may include driving around the bollard receiver 504, driving over the bollard receiver 504 so that the bollard receiver 504 passes between the vehicle's tires, or driving over the bollard receiver 504 so that the tread of the tires impacts the bollard receiver 504.

Returning to FIG. 3, the frame 300 represents an example frame of virtual sensor data generated by a simulation component 402, according to one embodiment. For example, the frame 300 may include a virtual image captured by a virtual camera located at a simulated position within a virtual environment. The frame 300 includes a bollard receiver 304 positioned within a virtual environment. The shape and position of the bollard receiver 304 within the frame 300 may be a result of the current position and orientation of the bollard receiver 304 as well as a virtual camera that has “captured” the frame 300. Virtual ground truth for the frame 300 may be saved with the frame 300 or may be associated with the frame 300 so that specific virtual conditions for the frame 300 are known. The virtual ground truth may include a distance (e.g., a simulated distance in feet, meters, or other measurement unit) between a sensor and the bollard receiver 304, an orientation of the sensor, an orientation of the bollard receiver 304, one or more dimensions of the bollard receiver 304, a material of the bollard receiver 304, specific positions of both the bollard receiver 304 and a sensor that captured the frame 300, simulated weather conditions, simulated time of day, simulated lighting positions, simulated lighting colors, or any other additional information about a simulated environment in which the frame 300 was captured.

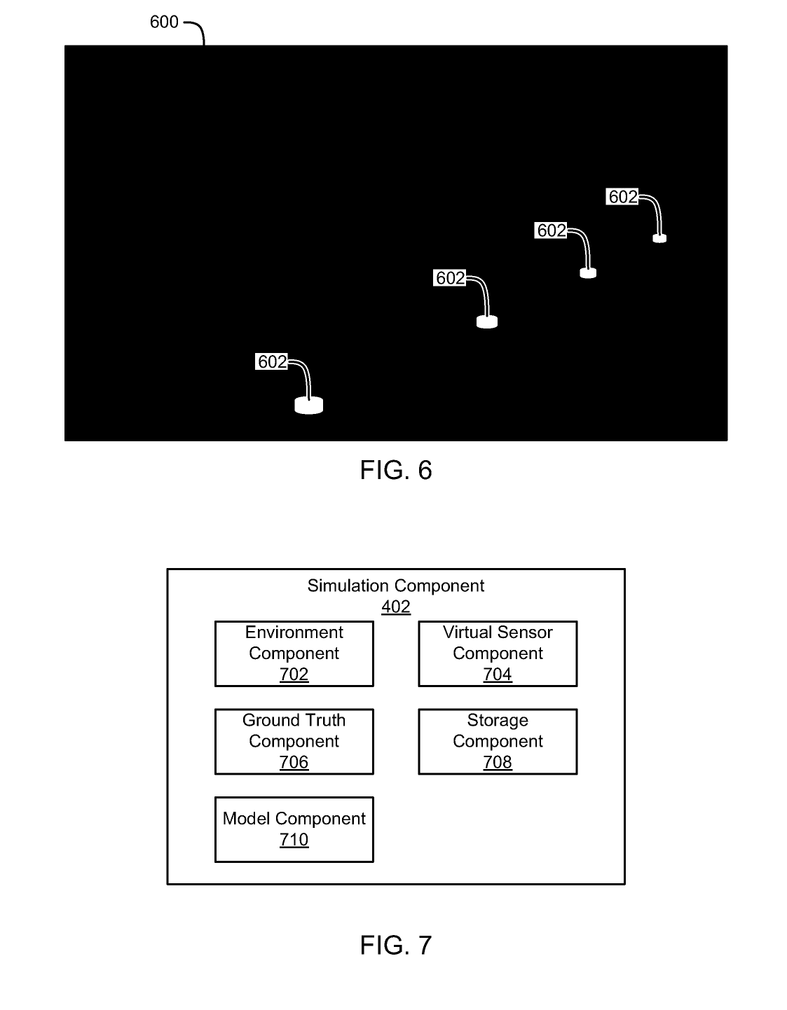

FIG. 6 illustrates one embodiment of a complimentary frame 600 corresponding to the frame 300 of FIG. 3. The complimentary frame includes regions 602 of a solid color that correspond to regions of the frame 300 where the pixels of bollard receivers 304 are located. In FIG. 6, the regions 602 are white, while the rest of the complimentary frame 600 is black. However, other embodiments may be similar to the original image with a solid color covering a region 602 of the bollard receivers. For example, a bright green color may be used for the region 602, while the black portion of the complimentary frame 600 may not be black, but may be identical to the corresponding regions/pixels of the original frame 300. In one embodiment, the complimentary frame 600 may be included in ground truth information for the frame 300 so that an algorithm may be trained or tested. For example, the complementary frame 600 may be provided with the frame 300 for training of a neural network that is used to detect and/or identify dimensions of a bollard receiver 304. It is important to note that neural networks or other machine learning algorithms may use portions of the original frame 300 outside the regions 602 for learning. For example, the regions 602 may be used as an indication of where bollard receivers are located, but environmental clues (e.g., road surface, painted lines, rows of bollard receivers, or the like) may also be used by a neural network or machine learning algorithm to identify and locate bollard receivers.

Although FIG. 3 and FIG. 6 are discussed above in relation to camera images, other types of sensor data frames are contemplated and fall within the scope of the present disclosure. For example, LIDAR frames, radar frames, ultrasound frames, or any other type of sensor data frame may be generated and stored. Additionally, although some embodiments and examples provided herein include the simulation and modeling of bollard receivers, any other type of object or data may be used. For example, virtual sensor data for any type of object that may be encountered in a driving environment may be generated. Example objects or obstacles may include bollard receivers, parking barriers or curbs, other vehicles, road or lane lines, parking lines, road signs, pedestrians, cyclists, animals, road debris, bumps or dips in a road, or any other object, obstacle or feature, which may alter how a vehicle should operate or alter a path of a vehicle.

FIG. 7 is a block diagram illustrating example components of a simulation component 402. In the depicted embodiment, the simulation component 402 includes an environment component 702, a virtual sensor component 704, a ground truth component 706, a storage component 708, and a model component 710. The components 702-710 are given by way of illustration only and may not all be included in all embodiments. In fact, some embodiments may include only one or any combination of two or more of the components 702-710. Some of the components 702-710 may be located outside the simulation component 402 such as within a computing device in communication with the simulation component 402 over a network.

The environment component 702 is configured to generate and/or simulate a virtual environment. In one embodiment, the environment component 702 simulates or generates a 3D parking or driving environment. The environment component 702 may use a 3D gaming or simulation engine for creating, simulating, and/or rendering an environment where a vehicle may be driven or parked. For example, gaming engines or 3D simulation engine used for driving games, 3D simulation, or any other game design or simulation may be used for purposes of simulating a real-world environment.

In one embodiment, the environment component 702 simulates an environment with a plurality of virtual objects. The virtual objects may include bollard receivers, parking barriers, vehicles, trees, plants, curbs, painted lines, buildings, landscapes, pedestrians, animals, or any other objects that may be found in a driving or parking environment. The environment component 702 may simulate crowded conditions where there are a large number of vehicles, pedestrians, or other objects. The environment component 702 may also simulate lighting conditions. For example, the environment component 702 may simulate a light source including a sun, moon light, street lights, building lights, vehicle headlights, vehicle brake lights, or any other light source. The environment component 702 may also simulate shadows, lighting colors for the sun or moon at different times of the day, or weather conditions. For example, the environment component 702 may simulate lighting for cloudy, rainy, snowy, and other weather conditions. Additionally, the environment component 702 may simulate wet or snow conditions where roads, parking lots, and objects in a virtual environment are wet or covered with snow.

In one embodiment, the environment component 702 may randomize simulated conditions. For example, the environment component 702 may periodically randomize one or more simulated conditions to generate environments having a wide array of conditions. In one embodiment, the environment component 702 may randomly generate different conditions for one or more of lighting, weather, a position of the one or more virtual bollard receivers or other objects, and dimensions of the one or more virtual bollard receivers or other objects.

In one embodiment, the environment component 702 may simulate a position of a sensor within the virtual environment. The environment component 702 may simulate movement of one or more sensors along a path within the virtual environment or may randomize sensor positioning. For example, the environment component 702 may simulate a position and/or orientation of a sensor based on a planned location on a vehicle. In one embodiment, the environment component 702 may randomize a position, height, orientation, or other positioning aspects of a sensor within the virtual environment. The randomized locations for the sensor, or other simulated conditions for the virtual environment may be randomized within predefined bounds to increase likelihood that the virtual environment is similar to conditions that would be encountered by vehicles in real-world situations.

The virtual sensor component 704 is configured to generate sensor data or perception data for a virtual sensor within a virtual environment generated or simulated by the environment component 702. In one embodiment, the virtual sensor component 704 may include or use a model of real-world performance of one or more specific sensors that are to be used by a vehicle. For example, a sensor may have a virtual model that simulates the real-world performance of the sensor. The virtual sensor component 704 may simulate how a sensor generates a frame. The virtual sensor component 704 may generate virtual sensor data that includes one or more of computer generated images, computer generated radar data, computer generated LIDAR data, computer generated ultrasound data, or other data for other types of perception sensors.

In one embodiment, the virtual sensor component 704 is configured to generate sensor frames or sensor data on a periodic basis. For example, the virtual sensor component 704 may generate an image (or other sensor) at a simulated interval similar to frequently a camera captures an image. In one embodiment, the virtual sensor component 704 creates sensor data for each position simulated by the environment component 702. For example, the virtual sensor component 704 may generate sensor data for positions along a path traveled by a virtual vehicle within a virtual environment. In one embodiment, one or more of the images or frames of sensor data include a portion of a virtual bollard receiver or other object. For example, computer generated images of bollard receivers or other objects in a virtual environment may be produced by the virtual sensor component 704.

The ground truth component 706 is configured to generate virtual ground truth for the virtual sensor data generated by the virtual sensor component 704. For example, the ground truth component 706 may determine simulated conditions for each image or frame captured by the virtual sensor component 704. In one embodiment, the environment component 702 may provide the simulated conditions to the ground truth component 706. The ground truth component 706 may select one or more simulated conditions as ground truth or calculate ground truth based on the simulated conditions for specific virtual sensor data. For example, the ground truth component 706 may select a dimension of a bollard receiver (such as height) as ground truth for a computer generated image or frame. As another example, the ground truth component 706 may receive virtual positions of a bollard receiver and a sensor and then calculate a virtual distance (e.g., line of sight distance and/or horizontal distance) between the virtual sensor and the bollard receiver. Similar information about other objects or obstacles within the virtual environment is also contemplated.

The virtual ground truth may include information about a position and orientation of a sensor, a position and orientation of a bollard receiver or other object, one or more dimensions of a bollard receiver or other object, lighting conditions, weather conditions, a distance between the sensor and the bollard receiver or other object, a type of sensor used to capture sensor data, or any other information about simulation conditions. In one embodiment, a uniform set of ground truth may be determined for each frame or set of sensor data generated by the virtual sensor component 704. For example, the same ground truth information (e.g., sensor height, distance, etc.) for each position where virtual sensor data was generated may be computed and stored.

In one embodiment, the ground truth component 706 may generate a complementary frame for a frame of sensor data generated by the virtual sensor component 704 (see FIG. 6). For example, the complementary frame may have the same color value for pixels corresponding to the one or more virtual bollard receivers. For example, each pixel corresponding to a bollard receiver may have the same color so that a training algorithm or a testing algorithm can clearly determine what portion of virtual sensor data corresponds to a virtual bollard receiver. In one embodiment, each pixel of the complementary frame may include an image pixel, radar or LIDAR vector, or other pixel or matrix value of virtual sensor data. In one embodiment, pixel values for one or more pixels in a region corresponding to the bollard receiver may be stored. For example, the pixel values may be stored instead of storing a full image. Pixel values for abounding box for a region surrounding a bollard receiver may also be stored as part of the ground truth.

The storage component 708 is configured to store the virtual sensor data generated by the virtual sensor component 704 and/or any ground truth determined by the ground truth component 706. For example, the storage component 708 may store the virtual sensor data and/or ground truth in the storage 404 of FIG. 4. In one embodiment, the storage component 708 may associate or annotate the virtual sensor data with corresponding ground truth or other information about simulated conditions. The sensor data and ground truth may then be used for a wide variety of purposes, such as for training a machine learning algorithm or model or for testing a machine learning algorithm or model.

The model component 710 is configured to provide the virtual sensor data and/or ground truth to an algorithm for testing or training of a machine learning algorithm or model. For example, the model component 710 may provide the virtual sensor data and/or the ground truth provided by the virtual sensor component 704 and/or ground truth component 706 to the training component 406 or testing component 408 of FIG. 4. In another embodiment, the model component 710 may include the training component 406 and/or the testing component 408. For example, the virtual sensor data and/or virtual ground truth may be used to train or test a neural network, deep neural network, and/or convolution neural network for detecting, identifying, determining one or more properties of a bollard receiver or other object. For example, the machine learning algorithm or model may be trained or tested for inclusion in the automated driving/assistance system 102 of FIG. 1. In one embodiment, the virtual sensor data and/or virtual ground truth may be used to train or test a neural network, deep neural network, and/or convolution neural network for determining how to maneuver in the presence of a bollard receiver to avoid damage to a vehicle.

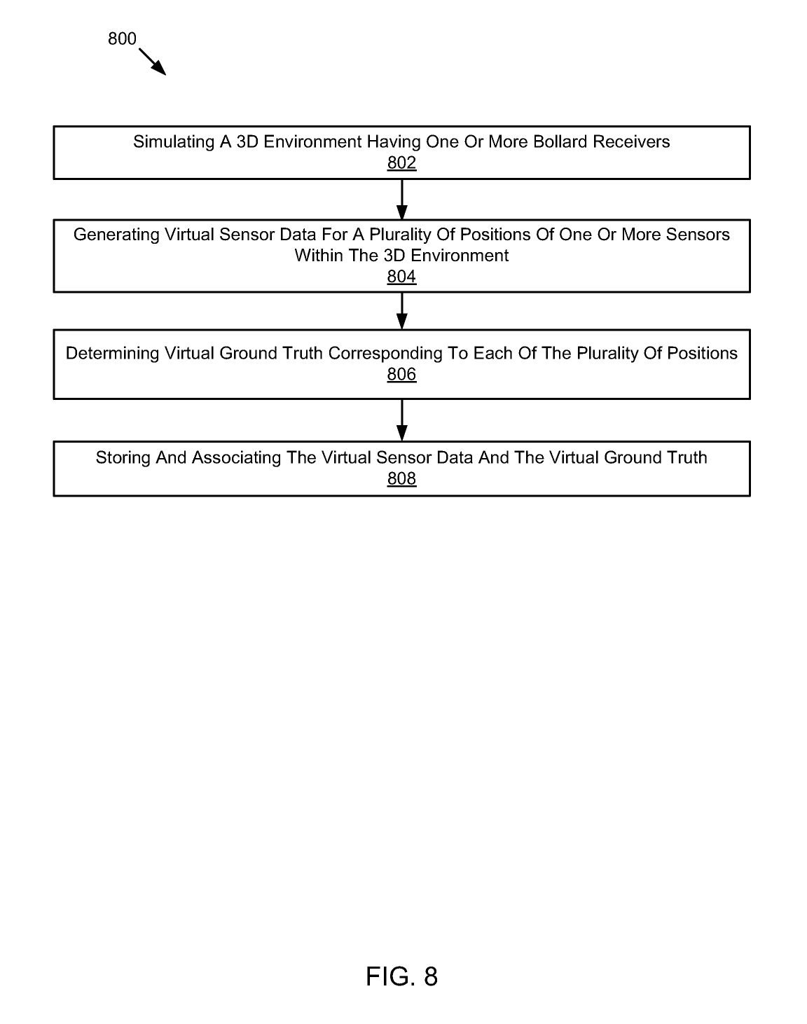

Referring now to FIG. 8, a schematic flow chart diagram of a method 800 for generating virtual sensor data and ground truth is illustrated. The method 800 may be performed by simulation component or a system for sensor data generation, such as the simulation component 402 of FIG. 4 or 7 or the system 400 for sensor data generation of FIG. 4.

The method 800 begins and an environment component 702 simulates at 802 a three-dimensional (3D) environment comprising one or more bollard receivers or other objects. A virtual sensor component 704 generates at 804 virtual sensor data for a plurality of positions of one or more sensors within the 3D environment. A ground truth component 706 determines at 806 virtual ground truth corresponding to each of the plurality of positions. The ground truth may include information about at least one bollard receiver within the virtual sensor data, such as a bollard receiver with one or more features captured in an image or other sensor data. The information may include any information about a bollard receiver or other object discussed herein, such as dimensions, position, or orientations of bollard receivers. For example, the ground truth may include a height of the at least one of the bollard receivers or other objects. A storage component 708 stores at 808 in storage and associates the virtual sensor data and the virtual ground truth. The method may also include a model component 710 providing the virtual sensor data and/or virtual ground truth to a training component 406 or a testing component 408 (see FIG. 4) for training or testing of a machine learning algorithm or model. After training and/or testing a model, such as a deep neural network, the model may be included in the vehicle control system 100 of FIG. 1 for active object or bollard receiver detection and dimension estimation during real-world driving conditions.

### Examples

The following examples pertain to further embodiments.

Example 1 is a method that includes simulating a 3D environment that includes one or more objects, such as bollard receivers. The method includes generating virtual sensor data for a plurality of positions of one or more sensors within the 3D environment. The method includes determining virtual ground truth corresponding to each of the plurality of positions. The ground truth includes information about at least one bollard receiver within the sensor data. For example, the ground truth may include a height of the at least one of the parking barriers. The method also includes storing and associating the virtual sensor data and the virtual ground truth.

In Example 2, the method of Example 1 further includes providing one or more of the virtual sensor data and the virtual ground truth for training or testing of a machine learning algorithm or model.

In Example 3, training the machine learning algorithm or model in Example 2 includes providing at least a portion of the virtual sensor data and corresponding virtual ground truth to train the machine learning algorithm or model to determine one or more of a height and a position of a bollard receiver represented within the portion of the virtual sensor data.

In Example 4, training the machine learning algorithm or model in any of Examples 2-3 includes providing at least a portion of the virtual sensor data to the machine learning algorithm or model to determine a location or height of the at least one bollard receiver and compare the location or height with the virtual ground truth.

In Example 5, testing the machine learning algorithm or model in any of Examples 2-4 includes providing at least a portion of the virtual sensor data to the machine learning algorithm or model to determine a classification or a position of at least one object and compare the classification or the position with the virtual ground truth.

In Example 6, the plurality of positions in any of Examples 1-5 correspond to planned locations of sensors on a vehicle, such as a planned height or angle with respect to a ground surface.

In Example 7, the virtual sensor data in any of Examples 1-6 includes one or more of computer generated images, computer generated radar data, computer generated LIDAR data, and computer generated ultrasound data.

In Example 8, simulating the 3D environment in any of Examples 1-7 includes randomly generating different conditions for one or more of lighting, weather, a position of the one or more bollard receivers, and a height or size of the one or more objects.

In Example 9, generating the virtual sensor data in any of Examples 1-8 includes periodically generating the virtual sensor data during simulated movement of the one or more sensors within the 3D environment.

In Example 10, determining the virtual ground truth in any of Examples 1-9 includes generating a ground truth frame complimentary to a frame of virtual sensor data, wherein the ground truth frame includes a same color value for pixels corresponding to the one or more objects.

In Example 11, determining the virtual ground truth in any of Examples 1-10 includes determining and logging, with respect to a frame or portion of virtual sensor data, one or more of: a pixel location for the at least one bollard receiver in a frame of virtual sensor data; a size of a bounding box around the at least one bollard receiver in a frame of virtual sensor data; a simulated position of the at least one bollard receiver relative to a vehicle or sensor in the 3D environment; and a simulated height of the at least one bollard receiver relative to ground surface in the 3D environment.

Example 12 is a system that includes an environment component, a virtual sensor component, a ground truth component, and a model component. The environment component is configured to simulate a 3D environment comprising one or more bollard receivers. The virtual sensor component is configured to generate virtual sensor data for a plurality of positions of one or more sensors within the 3D environment. The ground truth component is configured to determine virtual ground truth corresponding to each of the plurality of positions, wherein the ground truth includes information about at least one bollard receiver of the one or more bollard receivers. The model component is configured to provide the virtual perception data and the ground truth to a machine learning algorithm or model to train or test the machine learning algorithm or model.

In Example 13, the model component in Example 12 is configured to train the machine learning algorithm or model, wherein training includes providing at least a portion of the virtual sensor data and corresponding virtual ground truth to train the machine learning algorithm or model to identify or determine a position of the at least one bollard receiver.

In Example 14, the model component in any of Examples 12-13 is configured to test the machine learning algorithm or model. The testing includes providing at least a portion of the virtual sensor data to the machine learning algorithm or model to identify or determine a position of the at least one bollard receiver or object and comparing the identity, presence, or the position of the bollard receiver with the virtual ground truth.

In Example 15, the virtual sensor component in any of Examples 12-14 is configured to generate virtual sensor data comprising one or more of computer generated images, computer generated radar data, computer generated LIDAR data, and computer generated ultrasound data.

In Example 16, the environment component in any of Examples 12-15 is configured to simulate the 3D environment by randomly generating different conditions for one or more of the plurality of positions, wherein the different conditions comprise one or more of: lighting conditions; weather conditions; a position of the one or more bollard receivers; and dimensions of the one or more bollard receivers.

Example 17 is a computer readable storage media storing instructions that, when executed by one or more processors, cause the one or more processors to generate virtual sensor data for a plurality of sensor positions within a simulated 3D environment comprising one or more virtual bollard receivers. The instructions cause the one or more processors to determine one or more simulated conditions for each of the plurality of positions, wherein the simulated conditions comprise one or more of a presence, a position, and a dimension of at least one bollard receiver of the one or more bollard receivers. The instructions cause the one or more processors to store and annotate the virtual sensor data with the simulated conditions.

In Example 18, the instructions in Example 17 further cause the one or more processors to train or test a machine learning algorithm or model based on one or more of the virtual sensor data and the simulated conditions.

In Example 19, the instructions in any of Examples 17-18 further cause the processor to one or more of: train the machine learning algorithm or model by providing at least a portion of the virtual sensor data and corresponding simulated conditions to train the machine learning algorithm or model to determine one or more of a presence, a position, and a dimension of the at least one bollard receiver; and test the machine learning algorithm or model by providing at least a portion of the virtual sensor data to the machine learning algorithm or model to determine one or more of a classification, a position, and a dimension of the at least one bollard receiver and by comparing a determined classification, a position, and a dimension of the at least one bollard receiver with the simulated conditions.

In Example 20, generating the virtual sensor data in any of Examples 17-19 includes simulating the 3D environment by randomizing one or more of the simulated conditions for one or more of the plurality of positions, wherein randomizing the one or more simulated conditions comprises randomizing one or more of: lighting conditions; weather conditions; a position of the one or more virtual bollard receiver; and dimensions of the one or more virtual objects.

In Example 21, annotating the virtual sensor data with the simulated conditions in any of Examples 17-20 includes storing a log file that lists one or more of simulated conditions for each frame of virtual sensor data.

Example 22 is a system or device that includes means for implementing a method or realizing a system or apparatus as in any of Examples 1-21.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, “autonomous vehicle” may be a vehicle that acts or operates completely independent of a human driver; or may be a vehicle that acts or operates independent of a human driver in some instances while in other instances a human driver may be able to operate the vehicle; or may be a vehicle that is predominantly operated by a human driver, but with the assistance of an automated driving/assistance system.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
simulating a three-dimensional (3D) environment comprising one or more bollard receivers;
generating virtual sensor data for a plurality of positions of one or more sensors within the 3D environment;
determining virtual ground truth corresponding to each of the plurality of positions, the ground truth comprising information about at least one bollard receiver represented within the virtual sensor data; and
storing and associating the virtual sensor data and the virtual ground truth.

2. The method of claim 1, further comprising providing one or more of the virtual sensor data and the virtual ground truth for training or testing of a machine learning algorithm or model.

3. The method of claim 2, wherein training the machine learning algorithm or model comprises providing at least a portion of the virtual sensor data and corresponding virtual ground truth to train the machine learning algorithm or model to determine one or more of a height and a position of a bollard receiver represented within the portion of the virtual sensor data.

4. The method of claim 2, wherein testing the machine learning algorithm or model comprises providing at least a portion of the virtual sensor data to the machine learning algorithm or model to determine a location or height of the at least one bollard receiver and compare the location or height with the virtual ground truth.

5. The method of claim 1, wherein the plurality of positions correspond to a planned height or angle of sensors on a vehicle.

6. The method of claim 1, wherein the virtual sensor data comprises one or more of computer generated images, computer generated radar data, computer generated LIDAR data, and computer generated ultrasound data.

7. The method of claim 1, wherein simulating the 3D environment comprises randomly generating different conditions for one or more of lighting, weather, a position of the one or more bollard receivers, and a height or size of the one or more bollard receivers.

8. The method of claim 1, wherein generating the virtual sensor data comprises periodically generating the virtual sensor data during simulated movement of the one or more sensors within the 3D environment.

9. The method of claim 1, wherein determining the virtual ground truth comprises generating a ground truth frame complimentary to a frame of virtual sensor data, wherein the ground truth frame comprises a same color value for pixels corresponding to the one or more bollard receivers.

10. The method of claim 1, wherein determining the virtual ground truth comprises determining and logging, with respect to a frame or portion of virtual sensor data, one or more of:
a pixel location for the at least one bollard receiver in a frame of virtual sensor data;
a size of a bounding box around the at least one bollard receiver in a frame of virtual sensor data;
a simulated position of the at least one bollard receiver relative to a vehicle or sensor in the 3D environment; and
a simulated height of the at least one bollard receiver relative to ground surface in the 3D environment.

11. A system comprising:
an environment component configured to simulate a three-dimensional (3D) environment comprising one or more bollard receivers;
a virtual sensor component configured to generate virtual sensor data for a plurality of positions of one or more sensors within the 3D environment;
a ground truth component configured to determine virtual ground truth corresponding to each of the plurality of positions, wherein the ground truth comprises information about at least one bollard receiver of the one or more bollard receivers; and
a model component configured to provide the virtual perception data and the ground truth to a machine learning model or algorithm to train or test the machine learning model or algorithm.

12. The system of claim 11, wherein the model component is configured to train the machine learning algorithm or model, wherein training comprises:
providing at least a portion of the virtual sensor data and corresponding virtual ground truth to train the machine learning algorithm or model to identify or determine a position of the at least one bollard receiver.

13. The system of claim 11, wherein the model component is configured to test the machine learning algorithm or model, wherein testing comprises:
providing at least a portion of the virtual sensor data to the machine learning algorithm or model to identify or determine a position of the at least one bollard receiver; and
comparing the identity or the position of the bollard receiver with the virtual ground truth.

14. The system of claim 11, wherein the virtual sensor component is configured to generate virtual sensor data comprising one or more of computer generated images, computer generated radar data, computer generated light detection and ranging (LIDAR) data, and computer generated ultrasound data.

15. The system of claim 11, wherein the environment component is configured to simulate the 3D environment by randomly generating different conditions for one or more of the plurality of positions, wherein the different conditions comprise one or more of:
lighting conditions;
weather conditions;
a position of the one or more bollard receivers; and
dimensions of the one or more bollard receivers.

16. Computer readable storage media storing instructions that, when executed by one or more processors, cause the one or more processors to:
generate virtual sensor data for a plurality of sensor positions within a simulated three-dimensional (3D) environment comprising one or more bollard receivers;
determine one or more simulated conditions for each of the plurality of positions, wherein the simulated conditions comprise one or more of a presence, a position, and a dimension of at least one bollard receiver of the one or more bollard receivers; and
store and annotate the virtual sensor data with the simulated conditions.

17. The computer readable storage of claim 16, wherein the instructions further cause the one or more processors to train or test a machine learning algorithm or model based on one or more of the virtual sensor data and the simulated conditions.

18. The computer readable storage of claim 17, wherein one or more of:
the instructions cause the one or more processors to train the machine learning algorithm or model by providing at least a portion of the virtual sensor data and corresponding simulated conditions to train the machine learning algorithm or model to determine one or more of a presence, a position, and a dimension of the at least one bollard receiver; and
the instructions cause the one or more processors to test the machine learning algorithm or model by:
providing at least a portion of the virtual sensor data to the machine learning algorithm or model to determine one or more of a presence, a position, and a dimension of the at least one bollard receiver; and
comparing a determined presence, position, or dimension of the at least one bollard receiver with the simulated conditions.

19. The computer readable storage of claim 16, wherein generating the virtual sensor data comprises simulating the 3D environment by randomizing one or more of the simulated conditions for one or more of the plurality of positions, wherein randomizing the one or more simulated conditions comprises randomizing one or more of:
lighting conditions;
weather conditions;
a position of the one or more bollard receivers; and
dimensions of the one or more bollard receivers.

20. The computer readable storage of claim 16, wherein annotating the virtual sensor data with the simulated conditions comprises storing a log file that lists one or more of simulated conditions for each frame of virtual sensor data.
